(19) United States
(12) Patent Application Publication
(10) Pub. No.: US 2019/0294523 A1
(43) Pub. Date: Sep. 26, 2019

(54) ANOMALY IDENTIFICATION SYSTEM, METHOD, AND STORAGE MEDIUM

(71) Applicant: NEC Corporation, Minato-ku, Tokyo (JP)

(72) Inventor: Yasuhiro AJIRO, Tokyo (JP)

(73) Assignee: NEC Corporation, Minato-ku, Tokyo (JP)

(21) Appl. No.: 16/463,876

(22) PCT Filed: Dec. 1, 2017
(86) PCT No.: PCT/JP2017/043325

§ 371 Date: May 24, 2019

(30) Foreign Application Priority Data
Dec. 12, 2016 (JP) 2016-240125

(51) Int. Cl. G06F 11/34; G06K 9/62; G06F 11/07

(52) U.S. Cl. CPC G06F 11/3476; G06F 2201/86; G06F 11/079; G06K 9/6267

(57) ABSTRACT

An anomaly identification system includes: a log extraction unit that extracts a plurality of log subsets from target logs; a modeling unit that generates models from the plurality of log subsets; a correspondence acquisition unit that acquires a correspondence between the models and the plurality of log subsets that contribute to generation of the models; and a determination unit that classifies the plurality of log subsets into two log subset groups in accordance with presence or absence of contribution to generation of the models based on the correspondence, determines, out of the two log subset groups, a minority log subset group that includes the log subsets the number of which is smaller, and determines one of the plurality of log subsets having the highest specificity related to presence or absence of contribution to generation of the models based on the minority log subset group.

### TECHNICAL FIELD

The present invention relates to an anomaly identification system, a method, and a storage medium that identify an anomaly included in data output by a system.

### BACKGROUND ART

When an anomaly occurs in a system or the like, the cause of the anomaly is determined by investigating and analyzing a generated log or the like. Patent Literature 1 discloses a method that detects an anomaly of equipment or the like by using a multidimensional time-series sensor signal output from a sensor attached to the equipment or the like.

In the method disclosed in Patent Literature 1, learning data is generated by excluding a sensor signal in a certain section from the sensor signals in the predetermined section out of the multidimensional time-series sensor signals, and an anomaly determination threshold is calculated from the generated learning data. For anomaly detection, a normal model is generated by using learning data. In addition, a feature vector is extracted as an observation vector from the multidimensional time-series sensor signals. Further, an anomaly measure of the observation vector is calculated by using the extracted observation vector and the generated normal model. Such a comparison between the calculated anomaly measure of the observation vector and the anomaly determination threshold can be used for detection of the anomaly of the equipment or the like.

### CITATION LIST

### Patent Literature

PTL 1: Japanese Patent Application Laid-Open No. 2015-114967

### SUMMARY OF INVENTION

### Technical Problem

However, the method disclosed in Patent Literature 1 calculates an anomaly measure of the observation vector, and this needs to define the anomaly measure that represents the degree of the anomaly, and thus there is a problem of a large burden on a user.

Further, in the method disclosed in Patent Literature 1, for each section of a learning period in which learning data is generated, learning data is calculated from the remaining sensor signals excluding the sensor signals in the section, and this needs to calculate an anomaly measure of a feature vector extracted from the sensor signals in the section. Therefore, the method disclosed in Patent Literature 1 also has a problem of a large amount of calculation.

The example object of the present invention is to provide an anomaly identification system, a method, and a storage medium that enable identification of an anomaly in a target system with a small amount of calculation while reducing a burden on the user.

### Solution to Problem

According to one example aspect of the present invention, provided is an anomaly identification system including: a log extraction unit that extracts a plurality of log subsets from target logs in accordance with a predetermined condition, the number of the plurality of log subsets being three or more; a modeling unit that generates models from the plurality of log subsets extracted by the log extraction unit; a correspondence acquisition unit that acquires a correspondence between the models generated by the modeling unit and the plurality of log subsets that contribute to generation of the models; and a determination unit that classifies the plurality of log subsets into two log subset groups in accordance with the presence or absence of contribution to generation of the models based on the correspondence acquired by the correspondence acquisition unit, determines, out of the two log subset groups, a minority log subset group that includes the log subsets the number of which is smaller, and determines one of the plurality of log subsets having the highest specificity related to the presence or absence of contribution to generation of the models out of the plurality of log subsets based on the minority log subset group.

According to another example aspect of the present invention, provided is an anomaly identification method including: extracting a plurality of log subsets from target logs in accordance with a predetermined condition, the number of the plurality of log subsets being three or more; generating models from the plurality of log subsets; acquiring a correspondence between the models and the plurality of log subsets that contribute to generation of the models; classifying the plurality of log subsets into two log subset groups in accordance with the presence or absence of contribution to generation of the models based on the correspondence and determining, out of the two log subset groups, a minority log subset group that includes the log subsets the number of which is smaller; and determining one of the plurality of log subsets having the highest specificity related to the presence or absence of contribution to generation of the models out of the plurality of log subsets based on the minority log subset group.

According to yet another example aspect of the present invention, provided is a storage medium storing a program that causes a computer to execute: extracting a plurality of log subsets from target logs in accordance with a predetermined condition, the number of the plurality of log subsets being three or more; generating models from the plurality of log subsets; acquiring a correspondence between the models and the plurality of log subsets that contribute to generation of the models; classifying the plurality of log subsets into two log subset groups in accordance with the presence or absence of contribution to generation of the models based on the correspondence and determining, out of the two log subset groups, a minority log subset group that includes the log subsets the number of which is smaller; and determining one of the plurality of log subsets having the highest specificity related to the presence or absence of contribution to generation of the models out of the plurality of log subsets based on the minority log subset group.

### Advantageous Effects of Invention

According to the present invention, an anomaly in a target system can be identified with a small amount of calculation while reducing the burden on the user.

### BRIEF DESCRIPTION OF DRAWINGS

FIG. 1 is a schematic diagram illustrating an anomaly identification system and a target system according to an example embodiment of the present invention.

FIG. 2 is a block diagram illustrating a functional configuration of the anomaly identification system according to one example embodiment of the present invention.

FIG. 3 is a block diagram illustrating an example of a hardware configuration of the anomaly identification system according to one example embodiment of the present invention.

FIG. 4 is a flowchart illustrating an anomaly identification method using the anomaly identification system according to one example embodiment of the present invention.

FIG. 5 is a diagram illustrating an example of log subsets extracted based on time information in logs.

FIG. 6 is a diagram illustrating an example of models generated for the log subsets.

FIG. 7 is a diagram illustrating an example of a correspondence table representing a correspondence between merged models and the log subsets from which the merged models are obtained.

FIG. 8 is a diagram illustrating another example of the correspondence table representing the correspondence between the merged models and the log subsets from which the merged models are obtained.

FIG. 9 is a block diagram illustrating a functional configuration of an anomaly identification system according to another example embodiment of the present invention.

### DESCRIPTION OF EMBODIMENTS

### One Example Embodiment

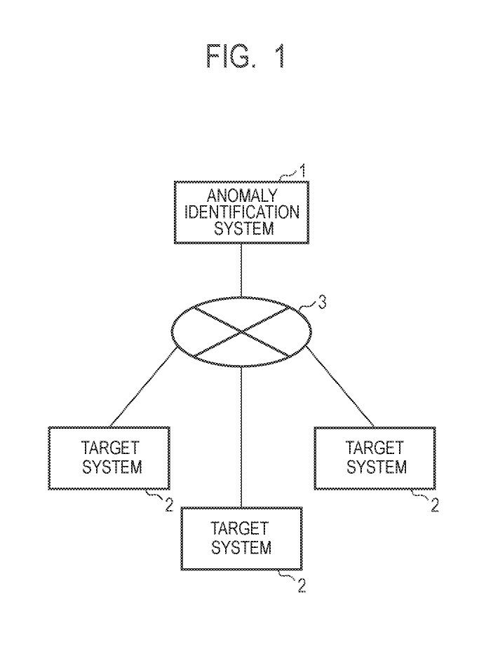

An anomaly identification system and an anomaly identification method according to one example embodiment of the present invention will be described by using FIG. 1 to FIG. 8.

First, a general configuration including the anomaly identification system and a target system, which is a target where an anomaly is to be identified, according to the present example embodiment will be described by using FIG. 1. FIG. 1 is a schematic diagram illustrating the anomaly identification system and the target system according to the present example embodiment.

As illustrated in FIG. 1, one or a plurality of target systems 2 that generate and output logs, which are targets of a process performed by an anomaly identification system 1, are communicably connected to the anomaly identification system 1 according to the present example embodiment via a network 3. While the network 3 may be Local Area Network (LAN) or Wide Area Network (WAN), for example, the type thereof is not limited. Further, the network 3 may be a wired network or a wireless network.

While not limited to a specific system, the target system 2 is an Information Technology (IT) system, for example. The IT system is formed of a device such as a server, a client terminal, a network device, or other information devices, or software such as system software or application software, which operates on the device. The target system 2 generates a log in which the contents of an event that occurred during operation, the situation during operation, or the like are stored. The log generated by the target system 2 is input to and processed by the anomaly identification system 1 according to the present example embodiment. Note that the anomaly identification system 1 according to the present example embodiment can target any entity as long as it is a system, a device, or an apparatus that generates a log and can process a log generated by the monitoring target.

In the anomaly identification system 1 according to the present example embodiment, a log generated by the target system is input thereto via the network 3. A manner in which the target system 2 inputs a log to the anomaly identification system 1 is not particularly limited and can be appropriately selected in accordance with the configuration of the target system 2 or the like.

For example, when a notification agent in the target system 2 transmits a log generated by the target system 2 to the anomaly identification system 1, the log can be input to the anomaly identification system 1. A protocol used for transmitting a log is not particularly limited and can be appropriately selected in accordance with the configuration or the like of a system that generates a log. For example, a syslog protocol, File Transfer Protocol (FTP), File Transfer Protocol over Transport Layer Security (TLS)/Secure Sockets Layer (SSL) (FTPS), or Secure Shell (SSH) File Transfer Protocol (SFTP) can be used as a protocol. Further, when the target system 2 shares the generated log with the anomaly identification system 1 through a file-sharing manner, the log can be input to the anomaly identification system 1. File sharing that shares the log is not particularly limited and can be appropriately selected in accordance with the configuration of the system that generates logs or the like. For example, file sharing by using Server Message Block (SMB) or Common Internet File System (CIFS) that is an extended SMB can be used as file sharing.

Note that the anomaly identification system 1 according to the present example embodiment is not necessarily required to be communicably connected to the target system 2 via the network 3. The anomaly identification system 1 may be communicably connected via the network 3 to a log collection system (not illustrated) that collects logs from the target system 2, for example. In such a case, logs generated by the target system 2 are once collected by the log collection system and are input to the anomaly identification system 1 from the log collection system via the network 3. Further, the anomaly identification system 1 according to the present example embodiment can also acquire a log from a storage medium that stores a log generated by the target system 2. In such a case, the target system 2 is not required to be connected to the anomaly identification system 1 via the network.

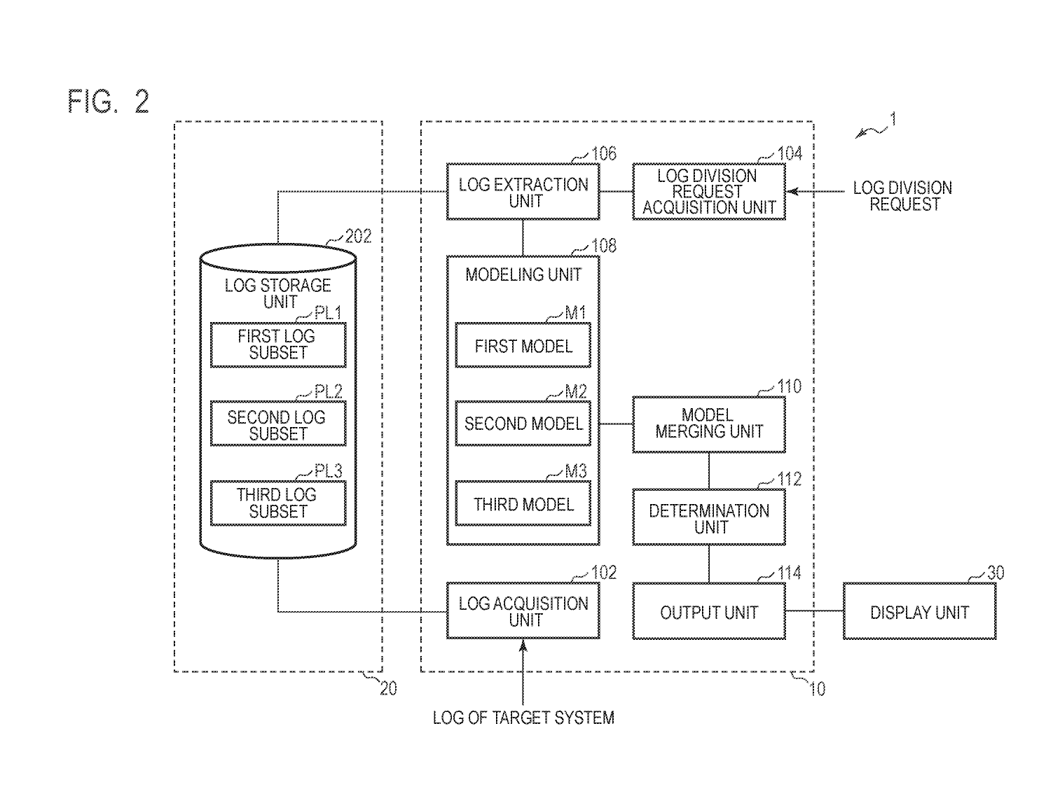

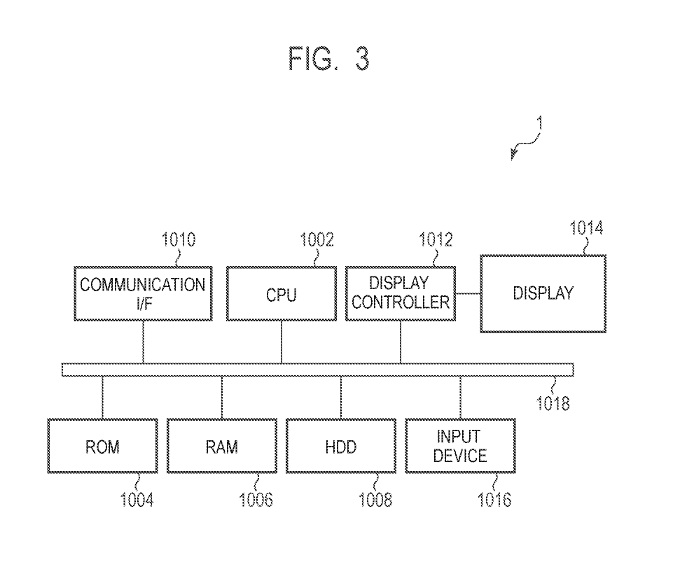

The specific configuration of the anomaly identification system 1 according to the present example embodiment will be further described below by using FIG. 2 and FIG. 3. FIG. 2 is a block diagram illustrating a functional configuration of the anomaly identification system according to the present example embodiment. FIG. 3 is a block diagram illustrating an example of the hardware configuration of the anomaly identification system according to the present example embodiment.

As illustrated in FIG. 2, the anomaly identification system 1 according to the present example embodiment has a processing unit 10 that performs various processes provided for identifying an anomaly in the target system 2. Further, the anomaly identification system 1 has a storage unit 20 that stores logs generated by the target system 2. Furthermore, the anomaly identification system 1 has a display unit 30 where a processing result is output and displayed.

The processing unit 10 has a log acquisition unit 102, a log division request acquisition unit 104, a log extraction unit 106, a modeling unit 108, a model merging unit 110, a determination unit 112, and an output unit 114.

The storage unit 20 has a log storage unit 202 that stores logs generated by the target system 2. Logs stored in the log storage unit 202 include a first log subset PL1, a second log subset PL2, and a third log subset PL3 that are extracted by the log extraction unit 106 described later. Note that, while a case where the number of log subsets is three will be described as an example in the present example embodiment, the number of log subsets is not limited thereto. The number of log subsets may be plural, and the number thereof may be three or more. The storage unit 20 is formed of a storage medium, for example. The storage unit 20 may be formed of the same storage medium or a plurality of storage media.

The display unit 30 displays a processing result output from the processing unit 10. The display unit 30 is formed of an output device such as a display, a printer, or the like.

A log that is a target of the process performed by the anomaly identification system 1 according to the present example embodiment is generated and output periodically or irregularly by the target system 2 or a component included therein. A log records the contents of an event, a situation during an operation, or the like occurring during an operation of the target system 2 or a component included therein. For example, the log is a message describing an event occurring at a certain time or a situation at a certain time. Further, in addition to the content of the event or the like, a log can further include another information such as a time stamp indicating the time when the log is generated, an Internet Protocol (IP) address of the component that generates the log, a name of the component that generates the log. Furthermore, a log may be text data in one or a plurality of lines and can include one or more fields as a unit of information, for example. A plurality of fields may be separated by a separator or a delimiter or may be continuous without being separated. A continuous field can be separated by a word, a morpheme, a character type, or the like.

In the present example embodiment, a log subset is a subset of target logs, which are the target of an anomaly identification process. The log subset is formed of log data that matches a specific condition related to time information included in the log, an IP address included in the log, a sampling time when the log is collected, or the like in the target log, for example.

The log storage unit 202 stores target logs input to the anomaly identification system 1. The target logs stored in the log storage unit 202 are divided into and extracted to the first log subset PL1, the second log subset PL2, and the third log subset PL3 by the log extraction unit 106, for example, as described later. The target logs are input to the log storage unit 202 periodically or irregularly or in real time, and the target logs stored in the log storage unit 202 are added and updated.

The anomaly identification system 1 according to the present example embodiment identifies an anomaly of the target system 2 by processing the target logs. Each unit included in the processing unit 10 will be described below in detail.

The log acquisition unit 102 acquires a target log input to the anomaly identification system 1 and stores the target log in the log storage unit 202 of the storage unit 20. The target log that is the log generated by the target system 2 is input to the anomaly identification system 1 periodically or irregularly or in real time. The log acquisition unit 102 stores the target log input in such a way in the log storage unit 202.

The log division request acquisition unit 104 externally acquires a log division request that requests division of the target logs stored in the log storage unit 202 and inputs the log division request to the log extraction unit 106. The division of the target logs is a process for extracting log subsets from the target logs. The log division request can be externally input to the anomaly identification system 1 by using an input device such as a keyboard, a touch panel, or the like, for example. Further, in the log division request, a condition related to time information included in the log, an IP address included in the log, collection time when the log is collected, or the like is included as a division condition used for dividing the target logs, for example. Further, the log division request can specify a range such as a time range of the target logs to be divided for extraction of log subsets.

The log extraction unit 106 divides the target logs stored in the log storage unit 202 and extracts the log subsets from the target logs in accordance with the log division request input from the log division request acquisition unit 104. The log extraction unit 106 extracts a divided portion of the target logs as a log subset in which the divided portion is obtained by dividing the target logs in accordance with the division condition of the division request, which is a predetermined condition. Further, when a range of the target logs required to be divided in accordance with the division request to extract a log subset is specified, the log subset is extracted in the specified range. In the log extraction unit 106, for example, the target logs are divided into three portions in accordance with the division condition of the division request, and the three divided portions are extracted as the first log subset PL1, the second log subset PL2, and the third log subset PL3. Note that the number of log subsets extracted by the log extraction unit 106 is not limited to three and may be three or more in accordance with the division condition.

The modeling unit 108 performs modeling for each log subset of the plurality of log subsets extracted by the log extraction unit 106. The modeling unit 108 generates a model representing regularity related to contents or occurrence manners of the log, patterns of the log, or the like for each log subset of the plurality of log subsets. For example, the modeling unit 108 performs modeling on the first log subset PL1, the second log subset PL2, and the third log subset PL3 extracted by the log extraction unit 106, respectively. Thereby, the modeling unit 108 generates a first model M1, a second model M2, and a third model M3 for the first log subset PL1, the second log subset PL2, and the third log subset PL3, respectively. Note that the model generated for the log subset by the modeling unit 108 is generally a model group including a plurality of models.

As a method of modeling the log subset by the modeling unit 108, for example, a method described in International Publication No. 2013/136418, Xia Ning, Geoff Jiang, Haifeng Chen, and Kenji Yoshihira, HLAer: “A System for Heterogeneous Log Analysis”, 2014 SDM Workshop on Heterogeneous Learning, April 2014 can be used. Note that a method of modeling is not particularly limited, and various methods can be used. For example, the model may be related to a co-occurrence relationship or an order relationship between logs. Further, the log data forming the target log may be numerical data such as numerical time series data, and a model in such a case may be related to the correlation or the like between items.

The model merging unit 110 merges a plurality of models generated for each log subset of a plurality of log subsets by the modeling unit 108. Further, the model merging unit 110 functions as a correspondence acquisition unit that acquires a correspondence between each model of the merged models and the log subset that contributes to generation of the model. When merging a plurality of models, the model merging unit 110 integrates a plurality of models that are generated from a plurality of log subsets and have identical contents into a single model. The model merging unit 110, which functions as the correspondence acquisition unit for example, generates a correspondence table representing the correspondence between each model of the merged models and the log subset that contributes to generation of the model to acquire the correspondence thereof.

Based on the correspondence between each model of the merged models and the log subset that contributes to generation of the model acquired by the model merging unit 110, the determination unit 112 determines a log subset that has the highest specificity related to the presence or absence of contribution to generation of a plurality of models. The log subset that has the highest specificity related to the presence or absence of contribution to generation of a plurality of models is a log subset that may contain an anomaly as described later.

Based on the correspondence, for example, the determination unit 112 determines a minority log subset group out of a plurality of log subsets related to the presence or absence of establishment of each model of the merged models. That is, for each model of the merged models, the determination unit 112 classifies the log subsets into two log subset groups in accordance with the presence or absence of contribution to generation of the model and determines, out of the two log subset groups, a minority log subset group including log subsets the number of which is smaller. Note that the minority log subset group may include a plurality of log subsets or only one log subset. Out of the two log subset groups, in the log subset group including log subsets the number of which is larger, that is, in the majority log subset group that is not the minority log subset group, two or more log subsets are included.

Further, the determination unit 112 provides a penalty, which is a predetermined value, to each of the log subsets included in the minority log subset group determined for each model of the plurality of models. The penalty can be an appropriate constant, specifically “1”, for example. The determination unit 112 then sums the penalties for all the models of the plurality of models for each log subset of the plurality of log subsets. The determination unit 112 can determine the log subset having the largest sum of the penalties for all the models out of the plurality of log subsets as the log subset having the highest specificity related to the presence or absence of contribution to generation of a plurality of models. The determination unit 112 notifies the output unit 114 of the log subset having the highest specificity determined in such a way.

Note that, when a penalty is provided, the determination unit 112 can provide penalties in accordance with a ratio of the number of log subsets included in the minority log subset group to the total number of the log subsets. Thereby, a higher penalty can be provided to the log subset included in the minority log subset group having a lower ratio to the total number of the log subsets. For example, the penalty can be provided by using the logarithm of M/N with N as the total number of log subsets and M as the number of the minority log subsets. That is, for example, the penalty can be calculated with −log (M/N) by using natural logarithm.

Further, in addition to the determination of the log subset having the highest specificity, the determination unit 112 can rank the plurality of log subsets in descending order of the calculated sum of the penalties and also notify the output unit 114 of the ranking result. Note that, while the determination unit 112 can rank the plurality of log subsets based on the calculated sum of the penalty, the determination unit 112 may rank the plurality of log subsets in ascending order of the calculated sum of the penalties.

When it is assumed that the number of anomalies included in logs generated by the target system 2 is small, the log subset having the highest specificity determined by the determination unit 112 can be regarded as being likely to include an anomaly. Further, the ranking result in which the log subsets are ranked in descending order of sum of the penalties can be regarded as a ranking in which the log subsets are arranged in descending order of possibility of including an anomaly. Therefore, based on the log subset having the highest specificity or the ranking result of the sum of the penalties obtained by the determination unit 112, the log subset having the possibility of including an anomaly can be determined. In such a way, the anomaly identification system 1 according to the present example embodiment can identify and determine an anomaly in the target system 2.

Note that, instead of providing a penalty to the log subset included in the minority log subset group, the determination unit 112 can also provide a reward to the log subset included in the majority log subset group, which is not the minority log subset group. In such a case, the determination unit 112 provides a reward, which is a predetermined value, to each log subset included in the majority log subset group, which is not the minority log subset group determined as described above for each model, out of the plurality of log subsets. The determination unit 112 then sums the rewards related to all the models for each log subset of the plurality of log subsets. The determination unit 112 can determine, out of the plurality of log subsets, a log subset having the smallest sum of the rewards related to all the models as a log subset having the highest specificity for the presence or absence of contribution to generation of a plurality of models.

Note that, when the rewards are provided, the determination unit 112 can provide the rewards in accordance with the ratio of the number of log subsets included in the majority log subset group to the total number of log subsets. Thereby, a higher reward can be provided to a log subset included in the majority log subset group that has a higher ratio to the total number of log subsets.

Further, in addition to determination of the log subset having the highest specificity, the determination unit 112 can rank the plurality of log subsets in ascending order of the calculated sum of the rewards and can also notify the output unit 114 of the ranking result. Note that, while the determination unit 112 can rank the plurality of log subsets based on the calculated sum of the rewards, the determination unit 112 may rank the plurality of log subsets also in descending order of the calculated sum of the rewards.

As described above, when it is assumed that the number of anomalies included in the logs generated by the target system 2 is small, the log subset in the minority log subset related to the presence or absence of establishment of the merged models determined by the determination unit 112 can be regarded as being likely to include an anomaly. In addition, the ranking result in which the log subsets are ranked in ascending order of sum of the rewards can be regarded as the ranking in which the log subsets are ranked in descending order of possibility of including an anomaly. Therefore, an anomaly in the target system 2 can be identified and determined based on the log subset having the highest specificity or the ranking result of the sum of the rewards obtained by the determination unit 112.

The output unit 114 outputs a log subsets having the highest specificity notified by the determination unit 112, which is a log subset that is likely to include an anomaly, to the display unit 30 to be displayed on the display unit 30. Further, the output unit 114 can also output the correspondence table representing the correspondence between each model generated by the model merging unit 110 and the log subset that contributes to generation of the model to the display unit 20 to be displayed on the display unit 30.

The anomaly identification system 1 described above is formed of a computer device, for example. An example of the hardware configuration of the anomaly identification system 1 will be described by using FIG. 3. Note that the anomaly identification system 1 may be formed of a single device or two or more devices that are physically separated and connected to each other by a wire or wirelessly.

As illustrated in FIG. 3, the anomaly identification system 1 has a central processing unit (CPU) 1002, a read only memory (ROM) 1004, a random access memory (RAM) 1006, and a hard disk drive (HDD) 1008. Further, the anomaly identification system 1 has a communication interface (I/F) 1010. Further, the anomaly identification system 1 has a display controller 1012 and a display 1014. Furthermore, the anomaly identification system 1 has an input device 1016. The CPU 1002, the ROM 1004, the RAM 1006, the HDD 1008, the communication I/F 1010, the display controller 1012, and the input device 1016 are connected to a common bus line 1018.

The CPU 1002 controls the entire operation of the anomaly identification system 1. Further, the CPU 1002 executes a program that implements a function of each unit of the log acquisition unit 102, the log division request acquisition unit 104, the log extraction unit 106, the modeling unit 108, the model merging unit 110, the determination unit 112, and the output unit 114 in the processing unit 10 described above. The CPU 1002 implements the function of each unit in the processing unit 10 by loading a program stored in the HDD 1008 or the like to the RAM 1006 and executing the program.

The ROM 1004 stores a program such as a boot program. The RAM 1006 is used as a working area when the CPU 1002 executes a program. Further, the HDD 1008 stores a program executed by the CPU 1002.

Further, the HDD 1008 is a storage device that implements a function of the log storage unit 202 in the storage unit 20 described above. Note that the storage device that implements the function of the log storage unit 202 is not limited to the HDD 1008. Various storage devices can be used as a device that implements the function of the log storage unit 202.

The communication I/F 1010 is connected to the network 3. The communication I/F 1010 controls data communication with the target system 2 connected to the network 3. The communication I/F 1010 implements a function of the log acquisition unit 102 in the processing unit 10 together with the CPU 1002.

The display controller 1012 is connected to the display 1014 that functions as the display unit 30. The display controller 1012 functions as the output unit 114 together with the CPU 1002 and displays the log subset in the minority log subset determined by the determination unit 112 on the display 1014. Further, the display controller 1012 that functions as the output unit 114 displays the correspondence table representing the correspondence between each model generated by the model merging unit 110 and the log subset in which the model is generated on the display 1014.

The input device 1016 may be a keyboard, a mouse, or the like, for example. Further, the input device 1016 may be a touch panel embedded in the display 1014. An operator of the anomaly identification system 1 can perform setting of the anomaly identification system 1 or input an execution instruction of a process via the input device 1016.

Note that the hardware configuration of the anomaly identification system 1 is not limited to the configuration described above, and various configurations can be applied.

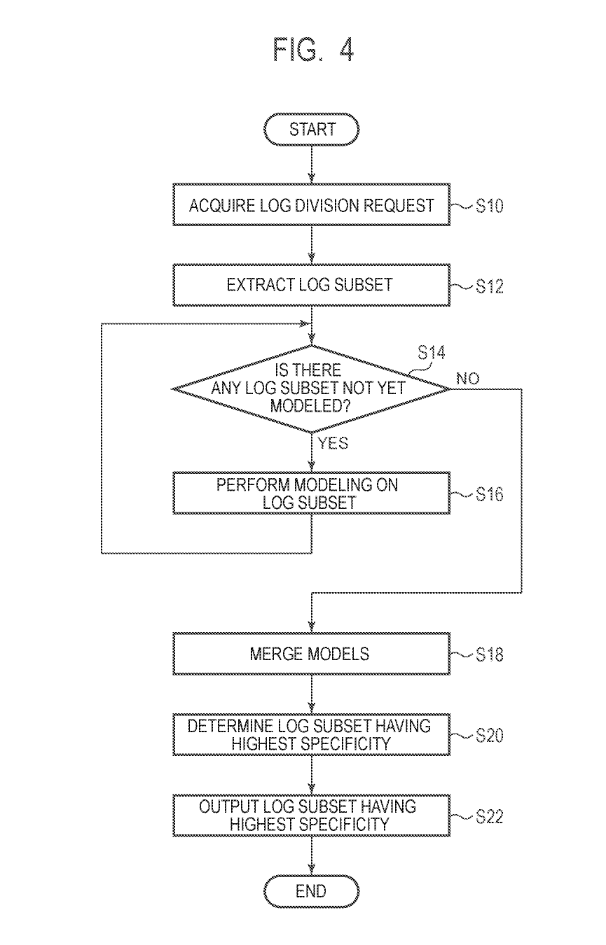

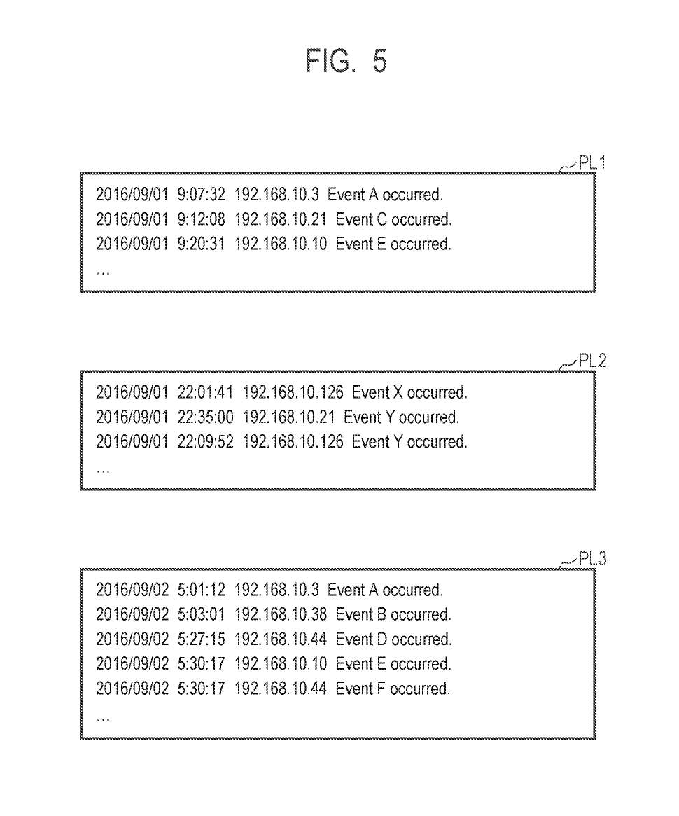

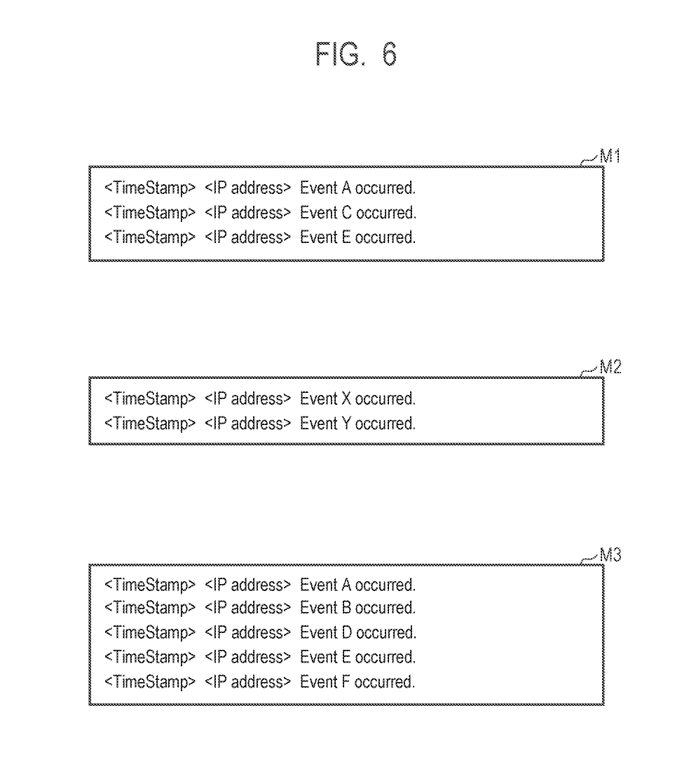

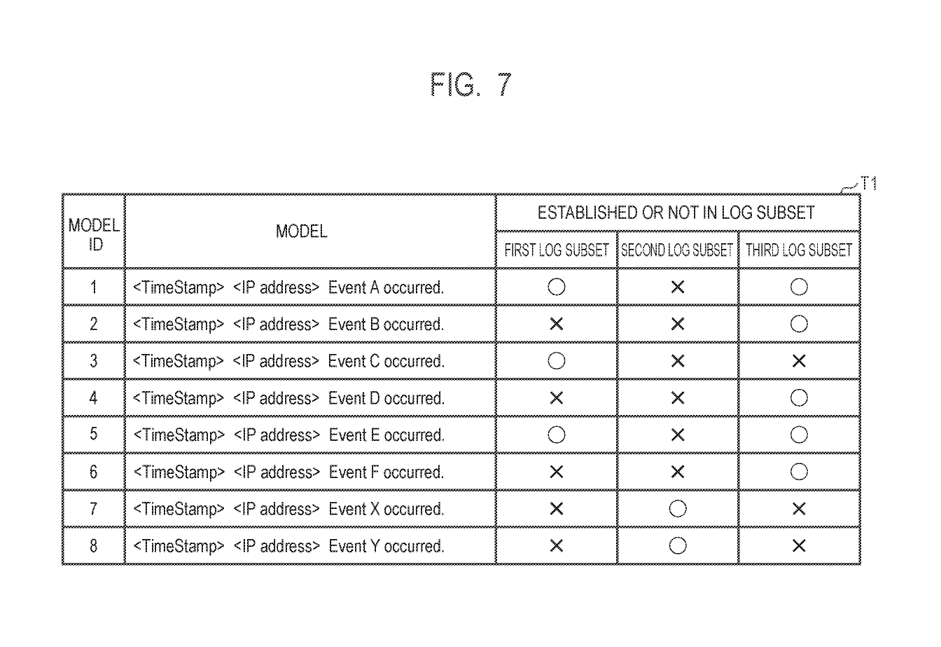

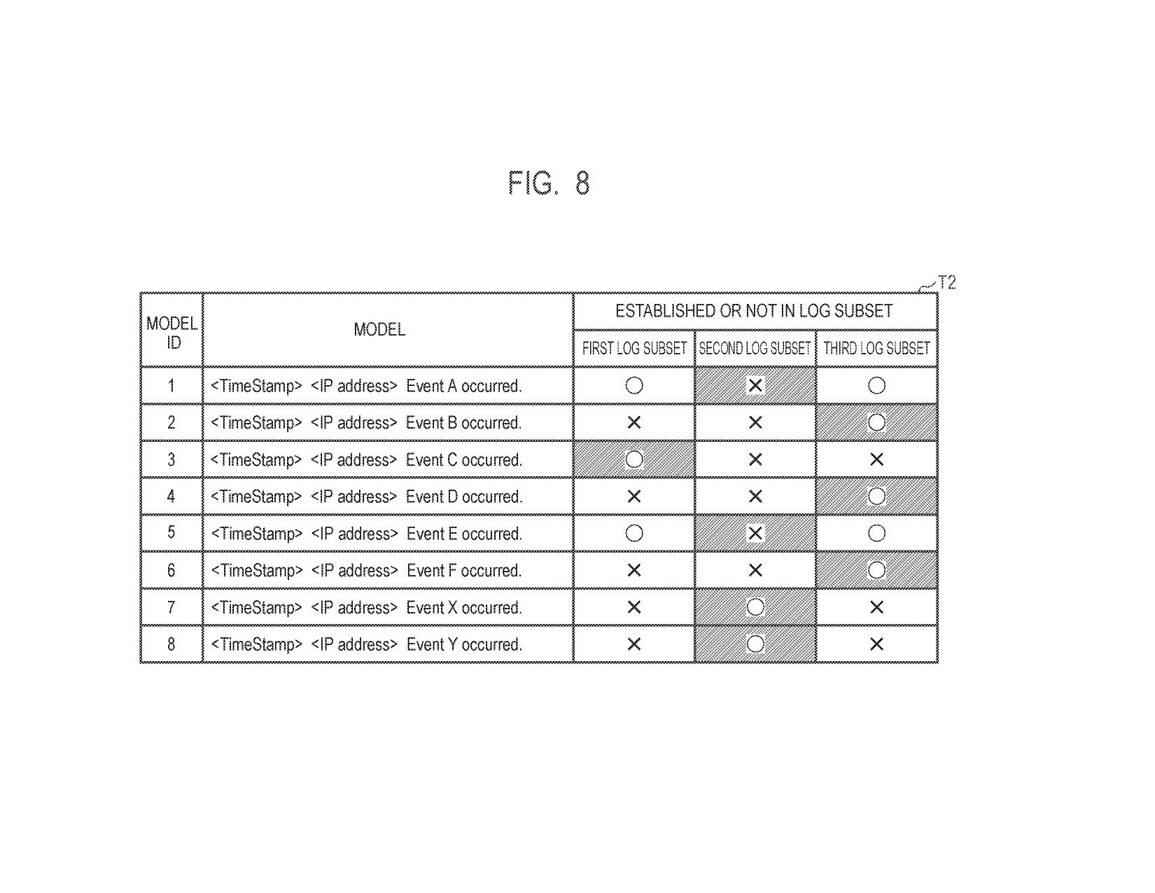

Next, the anomaly identification method by using the anomaly identification system 1 according to the present example embodiment described above will be further described by using FIG. 4 to FIG. 8. FIG. 4 is a flowchart illustrating the anomaly identification method using the anomaly identification system according to the present example embodiment. FIG. 5 is a diagram illustrating an example of log subsets extracted based on time information in the logs. FIG. 6 is a diagram illustrating an example of models generated for the log subsets. FIG. 7 and FIG. 8 are diagrams illustrating examples of a correspondence table representing a correspondence between the merged models and the log subsets from which the merged models are obtained, respectively.

In the anomaly identification system 1, logs generated by the target system 2 is input periodically or irregularly or in real time. The log acquisition unit 102 stores the logs input to the anomaly identification system 1 in the log storage unit 202. In such a way, the logs stored in the log storage unit 202 are added and updated periodically or irregularly or in real time.

First, the log division request is externally input to the anomaly identification system 1 via the input device 1016 or the like. The log division request acquisition unit 104 acquires the log division request input to the anomaly identification system 1 (step S10). The log division request requests execution of division of the target logs in order to extract a log subset from the target logs stored in the log storage unit 202.

In the log division request, for example, a condition related to time information, collection time when the log is collected, or the like included in the log can be included as a division condition used for division of the target logs. Specifically, an example that requests division of the target logs into three in accordance with the time periods of “9:00 to 17:59”, “18:00 to 4:49”, and “5:00 to 8:59” based on time information, collection time, or the like included in the log is illustrated as a log division request. Further, an example that requests division of the target logs into four based on IP addresses included in the logs of “192.168.10.1 to 192.168.10.99”, “192.168.10.100 to 192.168.10.199”, “192.168.10.200 to 192.168.10.255”, and a range of other IP addresses is illustrated as the log division request.

Note that, when the log storage unit 202 stores logs occurring over a long period or the like, the log division request can specify the time range of the target logs to be divided, in addition to the division conditions described above. For example, in the log division request, the time range of the target logs to be divided can be specified by a period such as “Sep. 1 to Sep. 30, 2016”.

The log division request acquisition unit 104 inputs the acquired log division request to the log extraction unit 106.

Next, in accordance with the log division request input by the log division request acquisition unit 104, the log extraction unit 106 divides the target logs stored in the log storage unit 202 and extracts a portion of divided target logs as a log subset (step S12).

FIG. 5 illustrates an example of three log subsets extracted from the target logs by the log extraction unit 106 based on time information in the logs. As illustrated in FIG. 5, the first log subset PL1, the second log subset PL2, and the third log subset PL3, which are three extracted log subsets, have different ranges of time information in the logs from each other. Note that, while text logs such as syslog are illustrated as the logs in FIG. 5, the log may be numerical data such as performance statistical data.

Next, the modeling unit 108 determines whether or not there is a model set that has not been modeled out of the plurality of log subsets extracted by the log extraction unit 106 (step S14). When a log subset that has not been modeled remains (step S14, YES), the modeling unit 108 performs modeling on the model set that has not been modeled (step S16).

In modeling on the model set, the modeling unit 108 generates a model representing regularity related to contents or occurrence manners of logs, patterns of logs, or the like for the log subset. Note that a method of modeling the log subset by the modeling unit 108 is not particularly limited as described above, and various methods can be used.

After step S16, the process proceeds to step S14, and steps S14 and S16 are repeated until there is no log subset that has not been modeled. Thereby, a model representing regularity related to contents or occurrence manners of logs, patterns of logs, or the like is generated for each log subset of the plurality of log subsets extracted by the log extraction unit 106.

FIG. 6 illustrates an example where a text log format included in each log subset extracted by the log extraction unit 106 is modeled (learned). A first model M1, a second model M2, and a third model M3 illustrated in FIG. 6 are models generated by performing modeling on the first log subset PL1, the second log subset PL2, and the third log subset PL3 illustrated in FIG. 5, respectively. The field enclosed by < > in FIG. 6 corresponds to a variable part in the format. The field <TimeStamp> denotes time, and the field <IP address> denotes an IP address. In a modeled log, the variable part is a specific time or an IP address.

When there is no model set that has not been modeled (step S14, NO), the model merging unit 110 merges a plurality of models generated on each log subsets of the plurality of log subsets by the modeling unit 108 (step S18). Further, the model merging unit 110 acquires a correspondence between each model of the merged models and the log subset that contributes to generation of the model thereof. The model merging unit 110, for example, generates a correspondence table representing a correspondence between each model of the merged models and the log subset that contributes to generation of the model thereof to acquire the correspondence therebetween.

FIG. 7 illustrates an example of the correspondence table representing a correspondence between each model of the models merged by the model merging unit 110 and the log subset that contributes to generation of the model thereof. Each model of the plurality of models included in the first model M1, the second model M2, and the third model M3 illustrated in FIG. 6, respectively, is merged in a correspondence table T1 illustrated in FIG. 7. Further, the correspondence table T1 illustrated in FIG. 7 represents which log subset out of the first log subset PL1, the second log subset PL2, and the third log subset PL3 illustrated in FIG. 5 establishes each merged model. That is, the correspondence table T1 illustrates the correspondence representing which log subset out of the first log subset PL1, the second log subset PL2, and the third log subset PL3 illustrated in FIG. 5 contributes to generation of each merged model.

In FIG. 7, a column that represents the presence or absence of establishment in the log subset illustrates which log subset out of the first log subset PL1, the second log subset PL2, and the third log subset PL3 establishes each of the eight models. It is indicated which log subset out of the first log subset PL1, the second log subset PL2, and the third log subset PL3 contributes to generation of each of the eight models. A circle mark in the correspondence table T1 indicates that the model of interest is established by the log subset of interest, that is, the log subset of interest contributes to generation of the model of interest. In contrast, an x mark in the correspondence table T1 indicates that the model of interest is not established by the log subset of interest, that is, the log subset of interest does not contribute to generation of the model of interest. The correspondence table T1 illustrates that a model with model ID of 1 is established by the first log subset PL1 and the third log subset PL3 but not established by the second log subset PL2, for example.

Next, the determination unit 112 determines a log subset that has the highest specificity related to the presence or absence of contribution to generation of the plurality of models based on the correspondence described above acquired by the model merging unit 110 (step S20).

Specifically, based on the correspondence described above, the determination unit 112 determines the minority log subset group out of the plurality of log subsets related to the presence or absence of establishment of each model of the merged models. That is, for each model of the merged models, the determination unit 112 classifies the log subsets into two log subset groups in accordance with the presence or absence of contribution to generation of the model and determines, out of the two log subset groups, the minority log subset group including the smaller number of log subsets.

Next, the determination unit 112 provides a penalty, which is a predetermined value, to each of the log subsets included in the minority log subset group determined for each model of the plurality of models. Next, the determination unit 112 sums the penalties of all the models of the plurality of models for each log subsets of the plurality of log subsets.

After the penalties are summed, the determination unit 112 determines, out of the plurality of log subsets, a log subset in which the sum of the penalties related to all the models is the highest as the log subset that has the highest specificity related to the presence or absence of contribution to generation of the plurality of models.

In the example illustrated in FIG. 7, for example, the model with model ID of 1 is established by the first log subset PL1 and the third log subset PL3 but not established by the second log subset PL2 as described above. That is, the first log subset PL1 and the third log subset PL3 contribute to generation of the model with model ID of 1, but the second log subset PL2 does not. Therefore, in the model with model ID of 1, the second log subset PL2 is included in the minority log subset group out of the first log subset PL1, the second log subset PL2, and the third log subset PL3. The determination unit 112 then provides a penalty to the second log subset PL2 in the model with model ID of 1. The penalty may be an appropriate constant, specifically “1”, for example.

In the example illustrated in FIG. 7, when the penalties provided as described above are summed for each log subset, the sum of the penalties of the first log subset PL1 is calculated as 1, the sum of the penalties of the second log subset PL2 is calculated as 4, and the sum of the penalties of the third log subset PL3 is calculated as 3.

Note that the determination unit 112 can provide a penalty in accordance with the ratio of the number of log subsets included in the minority log subset group to the total number of log subsets as described above. For example, the penalty can be calculated with −log (M/N) by using natural logarithm, for example, where N is the total number of log subsets and M is the number of minority log subsets. In the case of the example illustrated in FIG. 7, for example, the penalty of the second log subset PL2 related to the model with model ID of 1 is −log (⅓)=1.10. When the total number of log subsets is 10 and the number of minority log subsets is 2, the penalty provided to the minority log subsets is −log ( 2/10)=1.61.

Further, when all of the log subsets out of the plurality of log subsets contribute or do not contribute to generation of a model, the same value of penalty can be provided equally to all the log subsets, or no penalty is provided to all the log subsets. Further, when the number of the plurality of log subsets are even and the number of log subsets contributing to generation of the model and the number of log subsets not contributing to generation of the model are the same, the same value of penalty can be provided evenly to all the log subsets, or no penalty is provided to all the log subsets.

Further, in addition to determination of the minority log subset, the determination unit 112 can rank the log subsets in descending order of the calculated sum of the penalties.

Note that, as described above, instead of providing a penalty to the log subset included in the minority log subset group, the determination unit 112 can also provide a reward to the log subset included in the majority log subset group, which is not the minority log subset group.

The determination unit 112 notifies the output unit 114 of the log subset having the highest specificity related to the presence or absence of contribution to generation of the plurality of models determined as described above. Upon receiving the notification, the output unit 114 outputs the log subset having the highest specificity notified by the determination unit 112 to the display unit 30 and displays the output log subset on the display unit 30 (step S22). Note that, based on the sum of the penalties, the determination unit 112 can also notify the output unit 114 of the ranking result in which the log subsets are ranked. In such a case, upon receiving the notification, the output unit 114 outputs the ranking result obtained by the determination unit 112 to the display unit 30 and displays the output ranking result on the display unit 30.

Further, the output unit 114 can also output the correspondence table representing the correspondence between each model generated by the model merging unit 110 and the log subset that contributes to generation of the model thereof to the display unit 30 and display the output correspondence table on the display unit 30. For example, the output unit 114 can also output the correspondence table T1 illustrated in FIG. 7 to the display unit 30 and display the output correspondence table T1 on the display unit 30.

According to the present example embodiment as described above, in the plurality of log subsets extracted from the logs generated by the target system 2, the log subset that has the highest specificity related to the presence or absence of contribution to generation of the plurality of models can be automatically determined. When it is here assumed that the number of anomalies included in the logs generated by the target system 2 is small, the log subset that has the highest specificity determined by the determination unit 112 can be regarded as having the highest possibility of including an anomaly. Further, the ranking result in which the log subsets are ranked in descending order of sum of the penalties can be regarded as the ranking in which the log subsets are ranked in descending order of possibility of including an anomaly. Therefore, an anomaly in the target system 2 can be identified and determined based on the log subset having the highest specificity or the ranking result of the sum of the penalties obtained by the determination unit 112. Specifically, a period when an anomaly occurs in the target system 2, a network region (IP address band) where an anomaly occurs, a device or device groups where an anomaly occurs, or the like can be identified and determined.

Further, the present example embodiment can reduce a calculation amount required to identify an anomaly, that is, a calculation amount required to identify the log subset that has the highest specificity related to the presence or absence of contribution to generation of the plurality of models. That is, in the present example embodiment, the calculation amount required to determine the minority log subset can be expressed as f(A)×N, when a log amount of one log subset is denoted as A, a calculation amount required to model the log subset is denoted as a function related to the log amount f(A), and the number of the log subsets is denoted as N. On the other hand, according to the method disclosed in the Patent Literature 1, in addition that the post-learning calculation of an anomaly measure is required, a larger calculation amount required for learning corresponding to modeling is needed. For example, when it is assumed that there are three log subsets and each of log subsets has the same log amount, and when a calculation amount of the anomaly measure requires an amount denoted as a function of the log amount g(A), the calculation amount obtained by the method disclosed in Patent Literature 1 is (f(2A)+g(A))×N. Therefore, in the present example embodiment, it is possible to efficiently determine a log subset that may include an anomaly with a smaller calculation amount, compared to the method disclosed in Patent Literature 1.

Further, in the present example embodiment, since a log subset having the highest specificity can be regarded as being likely to include an anomaly, the anomaly measure that represents the degree of anomaly is not required to be defined unlike the method disclosed in Patent Literature 1. Therefore, a burden on the user can be reduced in the present example embodiment.

As described above, according to the present example embodiment, an anomaly in the target system can be identified with a small calculation amount while reducing a burden on the user.

Note that, in the correspondence table representing the correspondence between each model of the plurality of models and the log subset that contributes to generation of the model thereof, the determination unit 112 may emphasize the log subset included in the minority log subset group related to the presence or absence of establishment of each model, that is, related to the presence or absence of contribution to generation of each model. A method of emphasizing the log subset included in the minority log subset group is not particularly limited, and various methods such as an emphasizing method using a specific color or a mark can be used.

A correspondence table T2 illustrated in FIG. 8 is an example where the log subset included in the minority log subset group related to the presence or absence of establishment of each model, that is, related to the presence or absence of contribution to generation of each model is emphasized by hatching the background of the cells corresponding to the log subsets thereof in the correspondence table T1 illustrated in FIG. 7. In the correspondence table T2, for example, in the model with model ID of 1, the background of the cell corresponding to the second log subset PL2, which is a log subset included in the minority log subset group, is emphasized by hatching.

When the correspondence table T2 illustrated in FIG. 8 is obtained, for example, it is assumed that a user knows that the logs corresponding to the model with model ID of 7 are highly likely to be a log indicating an anomaly. In such a case, the user can easily recognize the presence of the log which is highly likely to be a log indicating an anomaly by the circle mark emphasized on the row of model ID of 7 in the correspondence table T2. Further, the user can easily determine that the log subset in which the log is included is the second log subset PL2. Therefore, a log subset having a possibility of including an anomaly can be more efficiently determined by the correspondence table T2.

### Another Example Embodiment

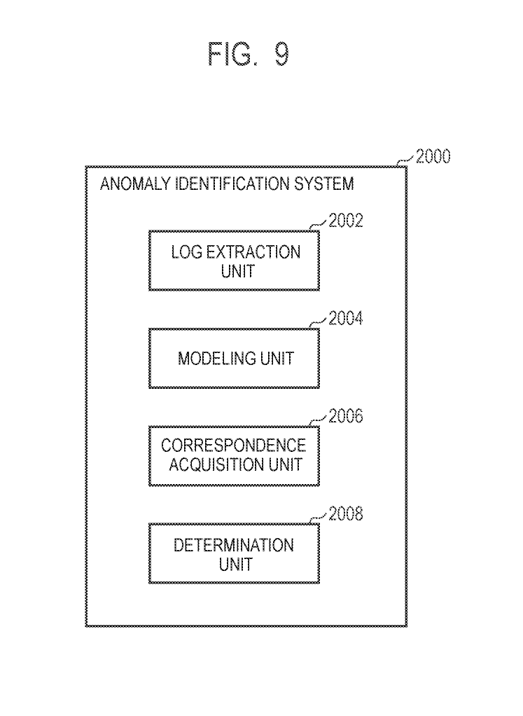

The anomaly identification system described in the example embodiment described above can be configured as illustrated in FIG. 9 according to another example embodiment. FIG. 9 is a block diagram illustrating a functional configuration of an anomaly identification system according to another example embodiment.

As illustrated in FIG. 9, the anomaly identification system 2000 according to another example embodiment has a log extraction unit 2002 that extracts a plurality of log subsets, the number of which is three or more, out of target logs in accordance with a predetermined condition. Further, the anomaly identification system 2000 has a modeling unit 2004 that generates models by using the plurality of log subsets extracted by the log extraction unit 2002. Further, the anomaly identification system 2000 has a correspondence acquisition unit 2006 that acquires a correspondence between the model generated by the modeling unit 2004 and the log subsets that contributes to generation of the model.

Further, the anomaly identification system 2000 has a determination unit 2008. Based on the correspondence acquired by the correspondence acquisition unit 2006, the determination unit 2008 classifies a plurality of log subsets into two log subset groups in accordance with the presence or absence of contribution to generation of the model and determines the minority log subset group, which includes log subsets the number of which is smaller, out of the two log subset groups. Further, based on the minority log subset group, the determination unit 2008 determines, out of the plurality of log subsets, the log subset having the highest specificity related to contribution to generation of the model.

### Modified Example Embodiments

The present invention is not limited to the example embodiment described above, and various modifications are possible.

For example, in the example embodiment described above, while the case where the log extraction unit 106 divides the target logs and extracts a plurality of log subsets has been described, the example embodiment is not limited thereto. The log extraction unit 106 may extract a plurality of log subsets out of the target logs in accordance with a predetermined extraction condition without division of the target logs generated by the target system 2.

Further, in the example embodiment described above, while the case where the model merging unit 110 generates the correspondence table that indicates the correspondence between each model and the log subsets in which the model is generated has been described, the example embodiment is not limited thereto. The model merging unit 110 may acquire the correspondence between each model and the log subsets in which the model is generated in not only in tabular format but also in various formats.

Further, a processing method of storing, in a storage medium, a program that operates the configuration of the example embodiments so as to implement a function of each example embodiment described above, reading the program stored in the storage medium as a code, and executing the program in a computer is included in the scope of each example embodiment. That is, a computer readable storage medium is included in the scope of each example embodiment. Further, not only the storage medium in which the computer program described above is stored but also the computer program itself is included in each example embodiment.

As the storage medium, for example, a floppy (registered trademark) disk, a hard disk, an optical disk, a magneto-optical disk, a compact disk-read only memory (CD-ROM), a magnetic tape, a nonvolatile memory card, and a ROM can be used. Further, not only a case where only the program stored in the storage medium executes a process but also a case where the program operates and executes a process on an operating system (OS) in cooperation with a function of other software or an expansion board is included in the scope of each example embodiment.

A service realized by the function of each example embodiment described above can be provided to a user in the form of Software as a Service (SaaS).

The whole or part of the example embodiments disclosed above can be described as, but not limited to, the following supplementary notes.

(Supplementary Note 1)

An anomaly identification system comprising:

a log extraction unit that extracts a plurality of log subsets from target logs in accordance with a predetermined condition, the number of the plurality of log subsets being three or more;

a modeling unit that generates models from the plurality of log subsets extracted by the log extraction unit;

a correspondence acquisition unit that acquires a correspondence between the models generated by the modeling unit and the plurality of log subsets that contribute to generation of the models; and

a determination unit that classifies the plurality of log subsets into two log subset groups in accordance with presence or absence of contribution to generation of the models based on the correspondence acquired by the correspondence acquisition unit, determines, out of the two log subset groups, a minority log subset group that includes the log subsets the number of which is smaller, and determines one of the plurality of log subsets having the highest specificity related to presence or absence of contribution to generation of the models out of the plurality of log subsets based on the minority log subset group.

(Supplementary Note 2)

The anomaly identification system according to supplementary note 1,

wherein the modeling unit generates the plurality of models from the plurality of log subsets, and

wherein the determination unit

determines the minority log subset groups and provides predetermined values to the log subsets included in the minority log subset group for the plurality of models, respectively, and

sums the predetermined values provided to the plurality of models for the plurality of log subsets, respectively.

(Supplementary Note 3)

The anomaly identification system according to supplementary note 2, wherein the determination unit determines the one of the plurality of log subsets having the highest specificity based on the sum of the predetermined values.

(Supplementary Note 4)

The anomaly identification system according to supplementary note 2 or 3, wherein the determination unit ranks the plurality of log subsets based on the sum of the predetermined values.

(Supplementary Note 5)

The anomaly identification system according to any one of supplementary notes 2 to 4, wherein the predetermined value is a value corresponding to a ratio of the number of the log subsets included in the minority log subset group to a total number of the plurality of log subsets.

(Supplementary Note 6)

The anomaly identification system according to any one of supplementary notes 1 to 5,

wherein the correspondence acquisition unit generates a correspondence table that represents the correspondence, and

wherein the determination unit emphasizes the log subsets included in the minority log subset group in the correspondence table.

(Supplementary Note 7)

An anomaly identification method comprising:

extracting a plurality of log subsets from target logs in accordance with a predetermined condition, the number of the plurality of log subsets being three or more;

generating models from the plurality of log subsets; acquiring a correspondence between the models and the plurality of log subsets that contribute to generation of the models;

classifying the plurality of log subsets into two log subset groups in accordance with presence or absence of contribution to generation of the models based on the correspondence and determining, out of the two log subset groups, a minority log subset group that includes the log subsets the number of which is smaller; and

determining one of the plurality of log subsets having the highest specificity related to presence or absence of contribution to generation of the models out of the plurality of log subsets based on the minority log subset group.

(Supplementary Note 8)

The anomaly identification method according to supplementary note 7 further comprising:

generating the plurality of models from the plurality of log subsets;

determining the minority log subset group and providing predetermined values to the log subsets included in the minority log subset group or included in a majority log subset group, which is not the minority log subset group, out of the two log subset groups for the plurality of models, respectively; and

summing the predetermined values provided to the plurality of models for the plurality of log subsets, respectively.

(Supplementary Note 9)

The anomaly identification method according to supplementary note 8 further comprising determining the one of the plurality of log subsets having the highest specificity based on the sum of the predetermined values.

(Supplementary Note 10)

The anomaly identification method according to supplementary note 8 or 9 further comprising ranking the plurality of log subsets based on the sum of the predetermined values.

(Supplementary Note 11)

The anomaly identification method according to any one of supplementary notes 8 to 10, wherein the predetermined value is a value corresponding to a ratio of the number of the log subsets included in the minority log subset group to a total number of the plurality of log subsets.

(Supplementary Note 12)

The anomaly identification method according to any one of supplementary notes 7 to 11 further comprising:

generating a correspondence table that represents the correspondence; and

emphasizing the log subsets included in the minority log subset group in the correspondence table.

(Supplementary Note 13)

A program that causes a computer to execute,

extracting a plurality of log subsets from target logs in accordance with a predetermined condition, the number of the plurality of log subsets being three or more,

generating models from the plurality of log subsets,

acquiring a correspondence between the models and the plurality of log subsets that contribute to generation of the models,

classifying the plurality of log subsets into two log subset groups in accordance with presence or absence of contribution to generation of the models based on the correspondence and determining, out of the two log subset groups, a minority log subset group that includes the log subsets the number of which is smaller, and

determining one of the plurality of log subsets having the highest specificity related to presence or absence of contribution to generation of the models out of the plurality of log subsets based on the minority log subset group.

While the present invention has been described with reference to the example embodiments, the present invention is not limited to the example embodiments described above. Various modifications that can be understood by those skilled in the art can be made to the configuration or the details of the present invention within the scope of the present invention.

This application is based upon and claims the benefit of priority from Japanese Patent Application No. 2016-240125, filed on Dec. 12, 2016, the disclosure of which is incorporated herein in its entirety by reference.

### REFERENCE SIGNS LIST

1 anomaly identification system
2 target system
10 processing unit
20 storage unit
106 log extraction unit
108 modeling unit
110 model merging unit
112 determination unit

What is claimed is:

1. An anomaly identification system comprising:
a log extraction unit that extracts a plurality of log subsets from target logs in accordance with a predetermined condition, the number of the plurality of log subsets being three or more;
a modeling unit that generates models from the plurality of log subsets extracted by the log extraction unit;
a correspondence acquisition unit that acquires a correspondence between the models generated by the modeling unit and the plurality of log subsets that contribute to generation of the models; and
a determination unit that classifies the plurality of log subsets into two log subset groups in accordance with presence or absence of contribution to generation of the models based on the correspondence acquired by the correspondence acquisition unit, determines, out of the two log subset groups, a minority log subset group that includes the log subsets the number of which is smaller, and determines one of the plurality of log subsets having the highest specificity related to presence or absence of contribution to generation of the models out of the plurality of log subsets based on the minority log subset group.

2. The anomaly identification system according to claim 1,
wherein the modeling unit generates the plurality of models from the plurality of log subsets, and
wherein the determination unit
determines the minority log subset groups and provides predetermined values to the log subsets included in the minority log subset group for the plurality of models, respectively, and
sums the predetermined values provided to the plurality of models for the plurality of log subsets, respectively.

3. The anomaly identification system according to claim 2, wherein the determination unit determines the one of the plurality of log subsets having the highest specificity based on the sum of the predetermined values.

4. The anomaly identification system according to claim 2, wherein the determination unit ranks the plurality of log subsets based on the sum of the predetermined values.

5. The anomaly identification system according to claim 2, wherein the predetermined value is a value corresponding to a ratio of the number of the log subsets included in the minority log subset group to a total number of the plurality of log subsets.

6. The anomaly identification system according to claim 1,
wherein the correspondence acquisition unit generates a correspondence table that represents the correspondence, and
wherein the determination unit emphasizes the log subsets included in the minority log subset group in the correspondence table.

7. An anomaly identification method comprising:
extracting a plurality of log subsets from target logs in accordance with a predetermined condition, the number of the plurality of log subsets being three or more;
generating models from the plurality of log subsets;
acquiring a correspondence between the models and the plurality of log subsets that contribute to generation of the models;
classifying the plurality of log subsets into two log subset groups in accordance with presence or absence of contribution to generation of the models based on the correspondence and determining, out of the two log subset groups, a minority log subset group that includes the log subsets the number of which is smaller; and
determining one of the plurality of log subsets having the highest specificity related to presence or absence of contribution to generation of the models out of the plurality of log subsets based on the minority log subset group.

8. The anomaly identification method according to claim 7 further comprising:
generating the plurality of models from the plurality of log subsets;
determining the minority log subset group and providing predetermined values to the log subsets included in the minority log subset group or included in a majority log subset group, which is not the minority log subset group, out of the two log subset groups for the plurality of models, respectively; and
summing the predetermined values provided to the plurality of models for the plurality of log subsets, respectively.

9. The anomaly identification method according to claim 8 further comprising determining the one of the plurality of log subsets having the highest specificity based on the sum of the predetermined values.

10. The anomaly identification method according to claim 8 further comprising ranking the plurality of log subsets based on the sum of the predetermined values.

11. The anomaly identification method according to claim 8, wherein the predetermined value is a value corresponding to a ratio of the number of the log subsets included in the minority log subset group to a total number of the plurality of log subsets.

12. The anomaly identification method according to claim 7 further comprising:
generating a correspondence table that represents the correspondence; and
emphasizing the log subsets included in the minority log subset group in the correspondence table.

13. A non-transitory storage medium in which a program is stored, the program causing a computer to execute,
extracting a plurality of log subsets from target logs in accordance with a predetermined condition, the number of the plurality of log subsets being three or more,
generating models from the plurality of log subsets,
acquiring a correspondence between the models and the plurality of log subsets that contribute to generation of the models,
classifying the plurality of log subsets into two log subset groups in accordance with presence or absence of contribution to generation of the models based on the correspondence and determining, out of the two log subset groups, a minority log subset group that includes the log subsets the number of which is smaller, and
determining one of the plurality of log subsets having the highest specificity related to presence or absence of contribution to generation of the models out of the plurality of log subsets based on the minority log subset group.
